(19) United States
(12) Patent Application Publication
(10) Pub. No.: US 2012/0005592 A1
(43) Pub. Date: Jan. 5, 2012

(54) Method and Apparatus for Providing Metadata-Based User Interfaces

(76) Inventor: Shrinivas B. Joshi, Austin, TX (US)

(21) Appl. No.: 12/827,226

(22) Filed: Jun. 30, 2010

(51) Int. Cl. G06F 3/048; G06F 17/28; G06F 3/041; G06F 3/01

(52) U.S. Cl. 715/746; 715/773; 704/2; 345/173; 704/E21.001

(57) ABSTRACT

Methods and apparatus provide for the production of metadata-based user interfaces (UIs) such as graphical user interfaces (GUIs). In one example, keypad descriptor metadata is obtained. The keypad descriptor metadata is data identifying a plurality of available keypad GUIs for a particular data field to control the change from a first keypad GUI to a different keypad GUI. The first keypad GUI is provided for the data field based on the obtained keypad descriptor metadata. A second and different keypad GUI is also provided for the same data field based on the keypad descriptor metadata during the same field population session. In another example, a user interface is provided for a device. The user interface is changed based on a current machine state of an input/output function of the device and based on user interface descriptor metadata associated with an element of the user interface.

### FIELD OF THE DISCLOSURE

The present disclosure relates to a method and apparatus for providing user interfaces.

### BACKGROUND OF THE DISCLOSURE

Many conventional electronic devices include user interfaces (UIs), which allow users to interact with software running on the devices. One type of user interface is the graphical user interface (GUI). As known in the art, GUIs frequently exist in the form of touch-screens. A variety of electronic devices utilize GUIs such as touch-screen keypads containing letters, numbers, grammatical operators (e.g., commas, question marks, quotation marks, etc.), special characters (e.g., asterisks, money signs, “@” symbols, etc.), and modifiers (e.g., “space,” “shift,” “tab,” “caps lock,” “enter,” “delete,” “num lock,” etc.). Oftentimes, such electronic devices have a limited amount of space on their screens that may be dedicated to such keypad GUIs. In an effort to make the most efficient use of available screen space, conventional electronic devices employ certain well-known techniques.

For example, one such technique involves switching a keypad GUI from a vertical display mode (i.e., portrait) to a horizontal (i.e., landscape) display mode when the physical orientation of the electronic device is manually rotated from a vertical orientation to a horizontal orientation relative to a user. This may be accomplished, for example, by the user rotating the device 90 degrees. This technique takes advantage of the fact that there is more screen space available for a touch-screen keypad GUI when the electronic device is held in a horizontal orientation than is available when the electronic device is held in a vertical orientation.

In another technique, the touch-screen keypad GUI might include a selectable icon representing a “switch key,” which allows the user to switch between a keypad GUI composed of, for example, alphabetic characters (e.g., a “QWERTY” keypad) to a keypad composed of, for example, numeric characters (i.e., a numeric keypad). Of course, some keypads might include a combination of alphabetic characters, numeric characters, grammatical operators, special characters, and/or modifiers. For example, many existing electronic devices employing this technique provide a keypad including the numeric characters 0-9 along with certain grammatical operators, special characters, and/or modifiers.

In another known technique, it is believed that the particular type of keypad GUI (e.g., QWERTY-type, numeric-type, etc.) that is displayed on an electronic device's screen at a given time is based on default rules programmed into the device. This type of technique is known as non-extensible hardcoding. As known in the art, extensibility is a system design principle where the implementation takes into consideration future growth. It is a systemic measure of the ability to extend a system and the level of effort required to implement the extension. The presently discussed technique exhibits non-extensible hardcoding in the sense that the rules governing which type of keypad GUI to display are based on a simplistic, static consideration. For example, one such known technique will switch from a numeric-type keypad GUI to an alphabetic-type keypad GUI each time that a user strikes the space-key. This default rule applies irrespective of the particular data field that a user is entering data into.

Furthermore, systems employing non-extensible hardcoding cannot be altered to permit consideration of additional factors when determining which keypad GUI to display a given time. For example, in one non-extensible hardcoded system, a particular keypad GUI (e.g., a numeric keypad GUI) is presented for display when a user is entering data in a particular data field (e.g., a ZIP code data field). However, such a system fails to allow for the consideration of additional factors (e.g., location of the device, orientation of the device, etc.) in determining which keypad GUI to present for display.

These conventional techniques suffer from a number of drawbacks. For example, it is time-consuming and inefficient for a user to have to manually select a “switch” key to switch from one type of keypad GUI to another. This is particularly true when a user is entering data into a data field that has a known structure.

For instance, in the United States, a mailing address is generally comprised of a string of numbers (i.e., street number) followed by a space, followed by a string of letters (i.e., street name). Using a conventional electronic device without non-extensible hardcoding, a user must go through the arduous task of selecting the switch key to switch from the default alphabetic keypad GUI to the numeric keypad GUI in order to enter the street number. The user must then select the switch key yet again to revert back to the alphabetic keypad GUI to enter the street name.

Using conventional non-extensible hardcoded electronic devices, a user would still have to select the switch key initially to switch from the default alphabetic keypad GUI to the numeric keypad GUI to enter the street number. However, in an electronic device having non-extensible hardcoding as discussed above, the display screen would automatically switch back from the numeric keypad GUI to the alphabetic keypad GUI upon a space-key keystroke following the entry of the street number, without necessitating both a space keystroke and a “switch” key keystroke, as would be required in the non-hardcoded system. While slightly more efficient than the system without non-extensible hardcoding, the non-extensible hardcoded system still requires a great deal of unnecessary user-input.

Accordingly, there exists a need for an improved method and apparatus for intelligently providing UI control, such as GUIs in an electronic device or other user interfaces. Also, UI control other than controlling keypad GUIs should also be improved to provide improved user experiences.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram generally depicting an apparatus in accordance with one example set forth in the present disclosure.

FIG. 2 is a block diagram generally depicting a GUI generator in accordance with one example set forth in the present disclosure.

FIG. 3 is a flowchart illustrating one example of a method for providing a graphical user interface.

FIG. 4 is a flowchart illustrating another example of a method for providing a graphical user interface.

FIG. 5 is an illustration of an apparatus having a first keypad GUI in accordance with one example set forth in the present disclosure.

FIG. 6 is an illustration of the apparatus of FIG. 5 having a second keypad GUI in accordance with one example set forth in the present disclosure.

FIG. 7 is an illustration of the apparatus of FIG. 6 in the horizontal (i.e., landscape) display mode in accordance with one example set forth in the present disclosure.

FIG. 8 is an illustration of the apparatus of FIG. 7 wherein a change in device location information has been detected and a user-prompt GUI has been provided in accordance with one example set forth in the present disclosure.

FIG. 9 is an illustration of an apparatus having a first keypad GUI that has been provided based on device location information in accordance with one example set forth in the present disclosure.

FIG. 10 is an illustration of the apparatus of FIG. 9 wherein a second keypad GUI has been provided based on user input into the first keypad GUI and device location information.

FIG. 11 is an illustration of the apparatus of FIG. 10 depicting an alternate embodiment of a second keypad GUI.

FIG. 12 is a flowchart illustrating one example of a method for providing a user interface.

### DETAILED DESCRIPTION OF THE PREFERRED EMBODIMENTS

The present disclosure provides an apparatus and methods for the production of metadata-based control of user interfaces such as graphical user interfaces (GUIs), keypad GUIs, a mouse, audio systems, vibration systems and other user interfaces.

In one example, a method for providing a user interface is disclosed. In this example, the method includes providing, for a device, a user interface. The user interface may be changed based on a current machine state of an input/output function of the device and based on user interface descriptor metadata associated with an element of the user interface. In one example, changing the user interface includes applying rule information to the user interface descriptor metadata to change the user interface from one of a plurality of available user interfaces to a different user interface (UI). In this example, the user interface could be a graphical user interface (GUI).

In another example, a method for providing a user interface is disclosed. In this example, user interface descriptor data is keypad descriptor metadata. The keypad descriptor metadata is data identifying a plurality of available keypad GUIs for a particular input data field to control the change from a first keypad GUI to a different keypad GUI. The first keypad GUI is provided for the data field based on the obtained keypad descriptor metadata. A second and different keypad GUI is also provided for the same data field based on the keypad descriptor metadata during the same field population session.

In one example of the above method, providing a keypad GUI includes applying rule information to the keypad descriptor metadata to determine which of the plurality of available keypad GUIs to alternatively display during the field population session. In another example, the keypad descriptor metadata defines which of the plurality of available keypad GUIs to alternatively display during the field population session. In yet another example, providing the second and different keypad GUI is also based on input into the first keypad GUI. In another example, obtaining the keypad descriptor metadata includes extracting the keypad descriptor metadata from an HTML form. In yet another example, the first keypad GUI is provided again (for a second time) for the same data field based on the keypad descriptor metadata during the same field population session.

In another method for providing a graphical user interface, keypad descriptor metadata identifying a plurality of available keypad GUIs for a same data field is obtained. A first keypad GUI is provided for the data field based on the obtained keypad descriptor metadata and device location information. A second and different keypad GUI is also provided for the same data field based on the keypad descriptor metadata and device location information during the same field population session. In one example, this method additionally includes changing a language associated with each keypad GUI from a first language to a second language based on the device location information. In another example, a user-prompt GUI is provided in response to detecting a change in device location information. In this example, the user-prompt GUI allows for the changing of a language associated with each keypad from a first language to a second language. In yet another example, the first keypad GUI is provided again (for a second time) for the same data field based on the keypad descriptor metadata and based on the device location information during the same data field population session.

An apparatus in accordance with the present disclosure includes a graphical user interface (GUI) generator. The GUI generator is operative to obtain keypad descriptor metadata as described above. The GUI generator is also operative to provide a first keypad GUI for the data field based on the keypad descriptor metadata and provide a second and different keypad GUI for the same data field based on the keypad descriptor metadata during a same field population session. The apparatus additionally includes a touch-screen display that is operatively connected to the GUI generator. This touch-screen display is operative to display at least one data field and the provided keypad GUI.

In one example, the apparatus additionally includes memory operatively connected to the GUI generator and operative to store rule information. In this example, the GUI generator is further operative to apply the rule information to the keypad descriptor metadata to determine which of the plurality of available keypad GUIs to alternatively provide for display on the touch-screen display during the field population session. In another example, each keypad GUI is operative to accept input via the touch-screen display. In this example, the GUI generator is further operative to provide the second and different keypad GUI based on input into the first keypad GUI. In another example in which the apparatus includes memory, the memory is operative to store an HTML form containing keypad descriptor metadata. This HTML form may be associated with, for example, any of the following data fields: an address field, a zip/postal code field, an email address field, a telephone number field, or a fax number field.

In another example, the apparatus may include a location-determining component in operative connection with the GUI generator for detecting apparatus location information. In this example, the GUI generator may include a rules engine. The rules engine of this example is operative to obtain keypad rule information, keypad descriptor metadata, and apparatus location information The rules engine is further operative to apply the rule information to the keypad descriptor metadata and the apparatus location information to determine which of the plurality of available keypad GUIs to alternatively provide for display on the touch-screen display during the field population session. In another example where the apparatus includes a location-determining component, the GUI generator may be further operative to provide a user-prompt GUI in response to the location-determining component detecting a change in the location of the apparatus. In this example, the user-prompt GUI allows for the changing of a language associated with each keypad GUI from a first language to a second language.

In addition to the problems or shortcomings discussed above, the inventors have recognized that conventional electronic devices fail to take into account the geographic location of the electronic device when presenting a user with a particular keypad GUI for data entry. For example, different countries follow different conventions with respect to, for example, ZIP/postal code. By way of example, the United States uses an entirely numeric structure for ZIP code. Conversely, Canada's postal code uses the following alphanumeric structure: letter, number, letter, space, number, letter, number (e.g., K2A 8F3). Entering a Canadian postal code using a conventional electronic device would be extremely inefficient in that it would require frequent manual switching between an alphabetic keypad GUI and a numeric keypad GUI.

Among other advantages, the disclosed apparatus and methods intelligently provide specific keypad GUIs based on metadata that has been appended (i.e., “tagged”) to a particular data field, thereby eliminating the time-consuming and inefficient need to manually switch between different keypad GUIs. The disclosed apparatus and methods also provide a more relevant keypad GUI at any given moment by taking into account considerations such as the geographic location of the device, the anticipated structure of data being entered into particular data fields, and the language that is spoken in particular geographic regions. Other advantages will be recognized by those of ordinary skill in the art.

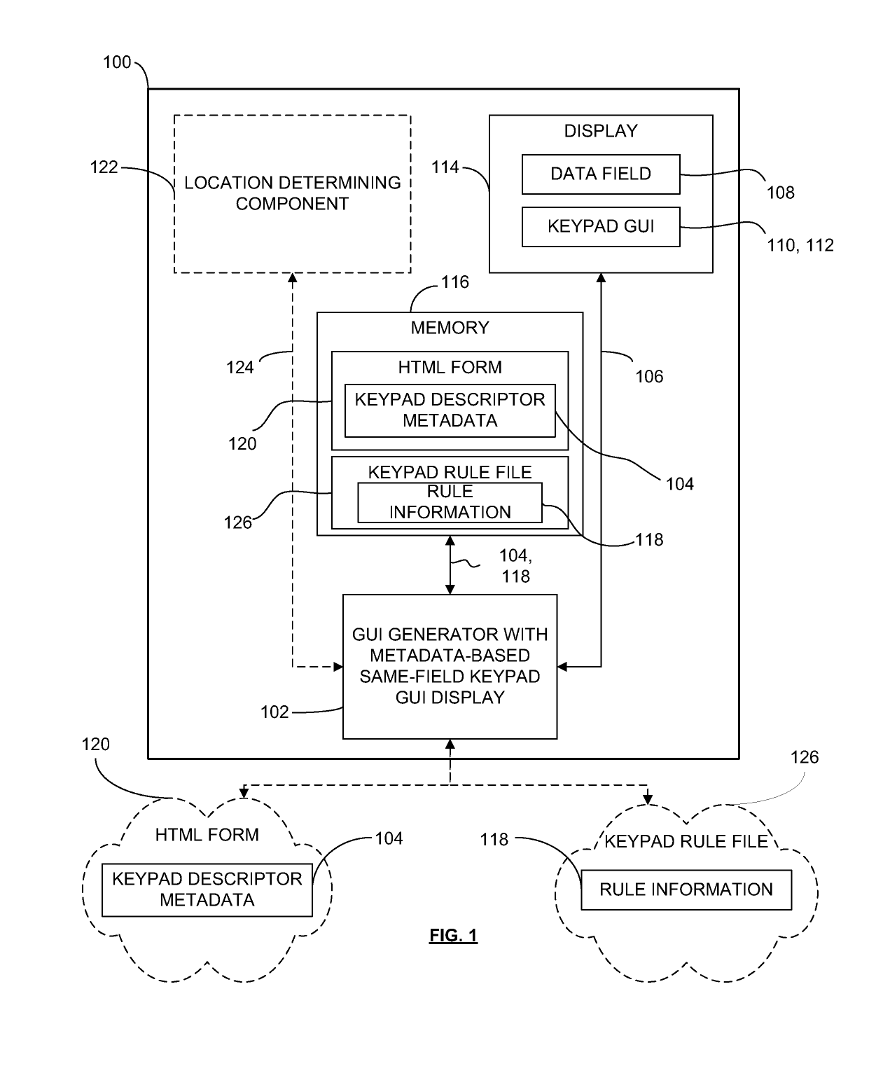

The following description of the embodiments is merely exemplary in nature and is in no way intended to limit the disclosure, its application, or uses. FIG. 1 illustrates one example of an apparatus 100, such as, but not limited to, any of the following electronic devices: a cellular telephone, a personal digital assistant (PDA), a tablet (e.g., an Apple® iPad®), a desktop or notebook PC, a camera, a self-service kiosk, an automated teller machine, a video game console (e.g., Nintendo DS®), a satellite navigation device, a networked computing device such as a server, or any other suitable electronic device. Apparatus 100 includes a GUI generator with metadata-based same-field keypad GUI display 102 (hereinafter “GUI generator”). The GUI generator 102 may comprise, for example, one or more processors (e.g., shared, dedicated, or group of processors such as but not limited to microprocessors, digital signal processors, or central processing units), combinational logic circuits, an application specific integrated circuit, state machine, and/or other suitable components that provide the described functionality.

The GUI generator 102 is operatively connected to a touch-screen display 114 over a suitable bus. As used herein, a touch screen display encompasses any electronic visual output capable of detecting the presence and location of a touch in the display area, irrespective of whether the touch comes from a living thing (e.g., a human finger) or an inanimate object (e.g., a stylus/pen). For example, the touch-screen display 114 may incorporate resistive technology, surface acoustic wave technology, capacitive technology, strain gauge technology, optical imaging technology, dispersive signal technology, acoustic pulse recognition technology, or any other suitable technology capable of affecting the desired functionality.

The GUI generator 102 is also operatively connected to memory 116 over a suitable bus. Memory 116 may be, for example, any combination of volatile/non-volatile memory components such as read-only memory (ROM), random access memory (RAM), electrically erasable programmable read-only memory (EE-PROM), or any other suitable digital storage medium. In one example, the GUI generator 102 is additionally operatively connected to a location-determining component 122 over a suitable bus. The location-determining component 122 may be, for example, a global positioning system (GPS) tracking unit such as a GPS logger (which logs the position of the device at regular intervals in its internal memory), a GPS transponder (which allows the location information of the device to be queried as desired), or any other suitable component capable of determining the location of the apparatus/device 100 (the terms “apparatus” and “device” are used interchangeably herein). For example, the location-determining component 122 could equally well apply cellular triangulation techniques to determine the location of the apparatus as known in the art. The device location information 124 may describe the location of the device in a variety of ways. For example, the location-determining component 122 might generate device location information 124 indicating the country that the device is in, the province/state/territory within a country that the device is in, the location of the device in degrees of latitude and longitude, or any other suitable means of describing the location of the device.

In operation, the GUI generator 102 obtains keypad descriptor metadata 104. The keypad descriptor metadata 104 may be obtained from, for example, a HTML form 102 that is permanently stored in memory 116 or provided remotely via, for example, the internet or a cellular channel (represented by the dashed cloud in FIG. 1). That is to say, the keypad descriptor metadata 104 may be appended to the HTML form 120 and stored in memory 116 during manufacture of the device 100, or alternatively, may be supplied to the device 100 post-manufacture, for example, via download through the internet using a web-browser application stored on the device 100 (e.g., via “over-the-air provisioning” or other like techniques known in the art).

As known in the art, HTML forms regularly define data fields that allow a user to enter information. Exemplary data fields include mailing address fields, zip/postal code fields, email address fields, telephone number fields, fax number fields, etc. Each data field generally has certain attributes defining the data field. For example, a given data field might have attributes corresponding to type, name, size, value, and/or length. A type attribute might define whether the data field is a text-type field (i.e., a data field wherein a user is permitted to enter text), a radio button-type field (i.e., a data field wherein a user is confined to selecting one of a plurality of available options), a check box-type field (i.e., a data field where a user can select more than one of a plurality of available options), or any other suitable data field types known in the art. A name attribute assigns a name to a given data field so that it may be referenced later by the programmer/author of the HTML form. A size attribute generally sets the horizontal and/or vertical dimensions of a data field (e.g., in the unit of measurement of blank spaces). A length attribute sets the minimum or maximum number of characters that may be entered in a given data field. Essentially, all of the aforementioned attributes comprise metadata describing the characteristics of a particular data field.

In accordance with the present disclosure, the HTML form 120 includes an additional attribute, referred to herein as keypad descriptor metadata 104, used to further define the characteristics of a given data field 108. While this disclosure generally discusses keypad descriptor metadata 104 as an extension of existing hyper-text markup language, it is envisioned that keypad descriptor metadata 104 could equally extend to other markup languages known in the art (e.g., XML, XHTML, etc.), or alternatively, could be included in a proprietary or new markup language generated by a developer as known in the art. That is to say, the particular markup language selected to implement the present disclosure does not affect the functionality of the keypad descriptor metadata 104 or any of the other components of the apparatus 100. Additionally, the use of keypad descriptor metadata could also be applied to non-markup language-based techniques to generate keypad GUIs, such as those provided by windowing toolkits supported by traditional programming languages such as C, C++, Java, or any other suitable programming language known in the art.

Nonetheless, the keypad descriptor metadata 104 comprises data identifying a plurality of available keypad GUIs for a same, or particular, data field 108. As used herein, a graphical user interface (GUI) is a user interface that can display information and allow users to interact with software running on the apparatus (e.g., via touch screen input). Broadly speaking, a GUI can encompass everything that is visually perceptible on a device's display screen 114 (e.g., a data field 108 and a keypad GUI 106). A keypad GUI 106, specifically, encompasses a plurality of selectable icons representing alphabetic characters, numeric characters, special characters, and/or modifiers as described above.

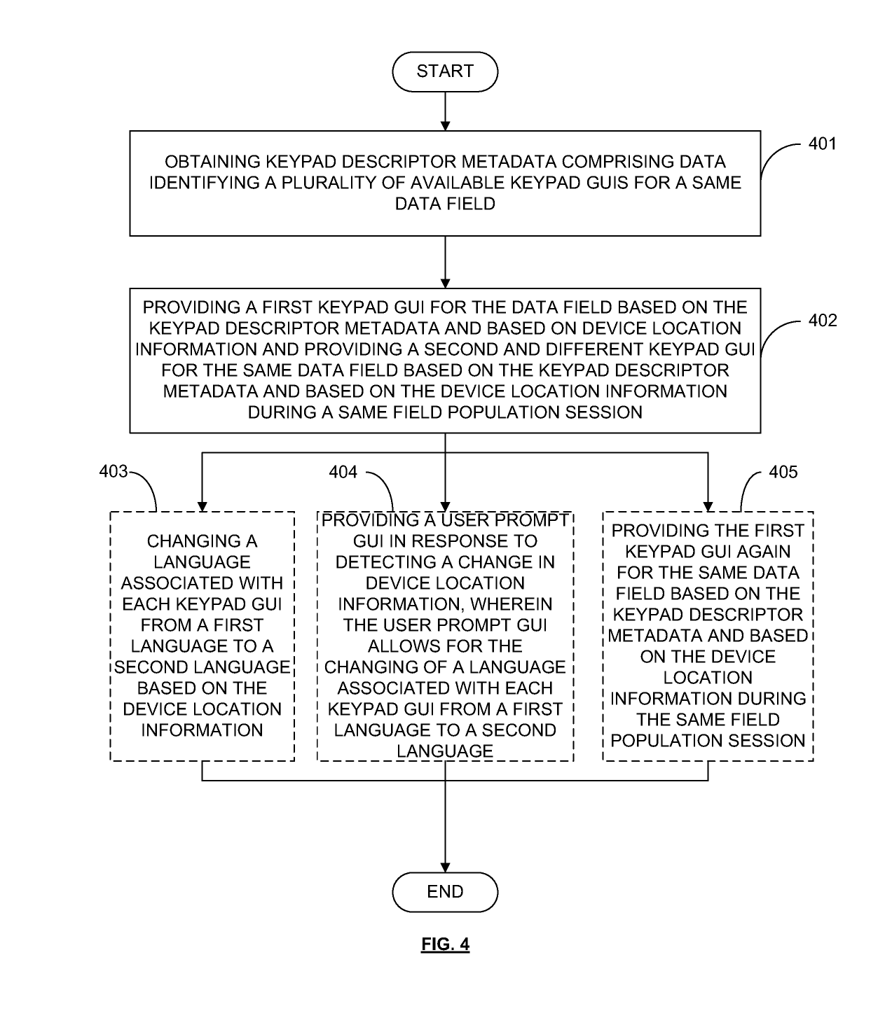

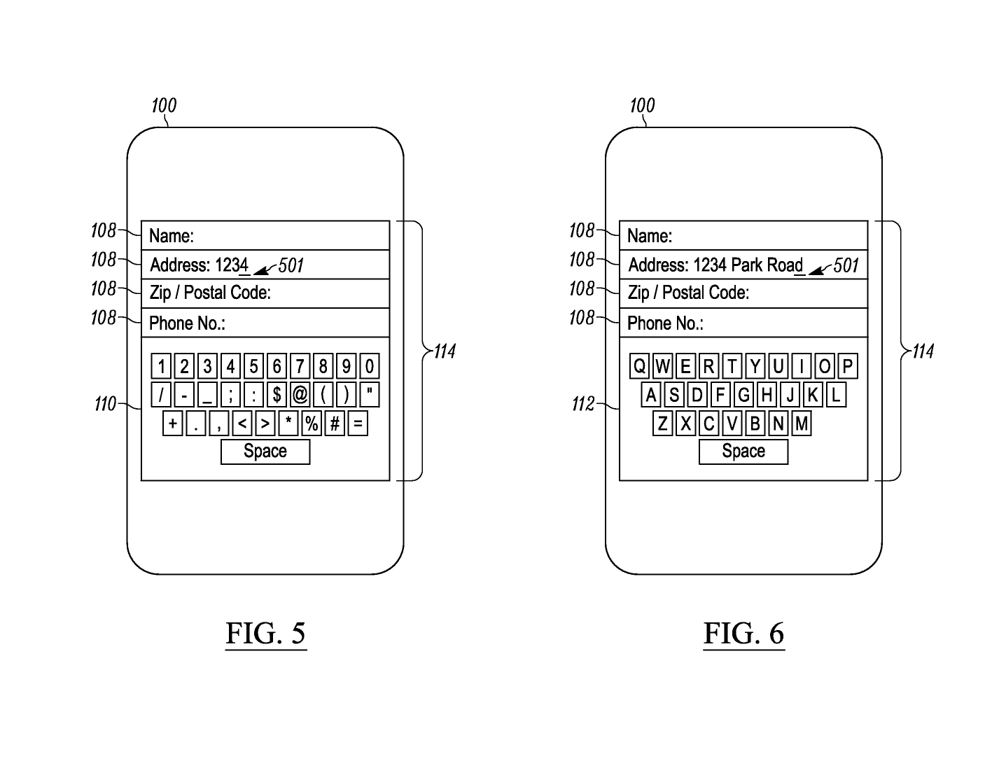

Keypad GUIs 106 may be of particular types. For example, and as best illustrated in FIG. 5, a first keypad GUI 110 includes selectable icons representing numeric characters, special characters, and modifiers. FIG. 6 illustrates a second keypad GUI 112 that includes selectable icons representing alphabetic characters (arranged in a QWERTY organization) and a modifier (the “space” key). Thus, keypad descriptor metadata 104 defines which particular type(s) of keypad GUI(s) 106 are available for display for a particular data field 108. Additionally, keypad descriptor metadata 104 may define when each available keypad GUI 106 should be displayed. For example, the keypad descriptor metadata 104 can indicate when the GUI generator should switch from, for example, providing a first keypad GUI 110 to providing a second and different keypad GUI 112. This functionality makes use of the knowledge that certain data fields 108 can expect the input to take on a specific structure.

For example, as previously noted, United States mailing addresses are structured as a series of numeric characters, followed by a space, followed by alphabetic characters (and possibly more spaces and alphabetic characters). Accordingly, keypad descriptor metadata 104 defining a mailing address data field 108 might instruct the GUI generator 102 to initially provide a first keypad GUI 110 including selectable icons representing only numeric characters and/or modifiers, so that a user can enter the street number. Following the entering of the street number (typically indicated by a user touching the “space” key icon), the same keypad descriptor metadata 104 might instruct the GUI generator 102 to provide a second and different keypad GUI 112 including selectable icons representing only alphabetic characters and/or modifiers, so that a user can enter the street name. Thus, the keypad descriptor metadata 104 may, in one example, instruct the GUI generator to provide both a first and second keypad GUI 110, 112 during the same field population session (i.e., while the user is entering data into a single data field 108). Furthermore, providing the second and different keypad GUI 112 may also be based on input into the first keypad GUI 110, for example, by touching the space key on the first keypad GUI 110.

Continuing with the operation of the GUI generator 102, as discussed above, the GUI generator 102 is operative to obtain keypad descriptor metadata 104 and then provide first and second keypad GUIs 110, 112 based on the obtained keypad descriptor metadata 104 during the same data field population session. The act of obtaining the keypad descriptor metadata 104 may include extracting (i.e., making a copy of) the keypad descriptor metadata 104 from the HTML form 120 (regardless of whether the form 120 is permanently stored in apparatus memory 116 or obtained remotely via, for example, the internet or a cellular channel). Alternatively, extracting could include removing the keypad descriptor metadata 104 from the form for use by the GUI generator 102.

After obtaining the keypad descriptor metadata 104, the GUI generator provides keypad GUIs 106 to the touch-screen display 114. The touch-screen display 114 may comprise an integral or external display such as a cathode-ray tube (CRT), liquid crystal display (LCD), light-emitting diode (LED) display, or any other suitable display equipped with touch-screen responsiveness as described above. The touch-screen display 114 is operative to display at least one data field 108 and the provided keypad GUI 106. For example, as illustrated in FIG. 5, the touch screen display 114 is shown displaying several data fields 108 (i.e., name, address, zip/postal code, phone no.) and a first keypad GUI 110.

In accordance with one example of the present disclosure, the GUI generator 102 is operative to apply rule information 118 to the keypad descriptor metadata 104 to determine which of the plurality of available keypad GUIs 106 to alternatively provide for display on the touch-screen display 114 during the data field population session. The GUI generator 102 may obtain the rule information 118 from one or more keypad rule files 126 stored in memory 116. The rule files may comprise, for example, text files containing rule information 118 specifying the desired behavior of the GUI generator 102 in certain circumstances. As discussed with respect to the HTML forms 120 above, the rule files 126 (and thus rule information 118) may also be obtained, for example, via download through the internet using a web-browser application stored on the device 100 (e.g., via “over-the-air provisioning” or other like techniques known in the art).

The rule information 118 may further define which type of keypad GUI 106 should be provided for display, and when a particular keypad GUI 106 should be provided for display. For instance, the GUI generator 102 may apply the rule information 118 to the keypad descriptor metadata 104 to determine which particular keypad GUI 106 to provide for display at a given time. By way of example, the keypad descriptor metadata 104 might merely define which particular keypad GUIs 106 are available to be alternatively displayed for a particular data field 108. However, the keypad descriptor metadata 104 might be silent as to when a switch should be made from a first keypad GUI 110 to a second and different keypad GUI 112. In such a case, the rule information 118 could be applied to the keypad descriptor metadata 104, which rule information 118 would then dictate to the GUI generator 102 when to switch from a first keypad GUI 110 to a second and different keypad GUI 112. For example, the rule information 118 might indicate that a switch should occur following a user touching the “space” key.

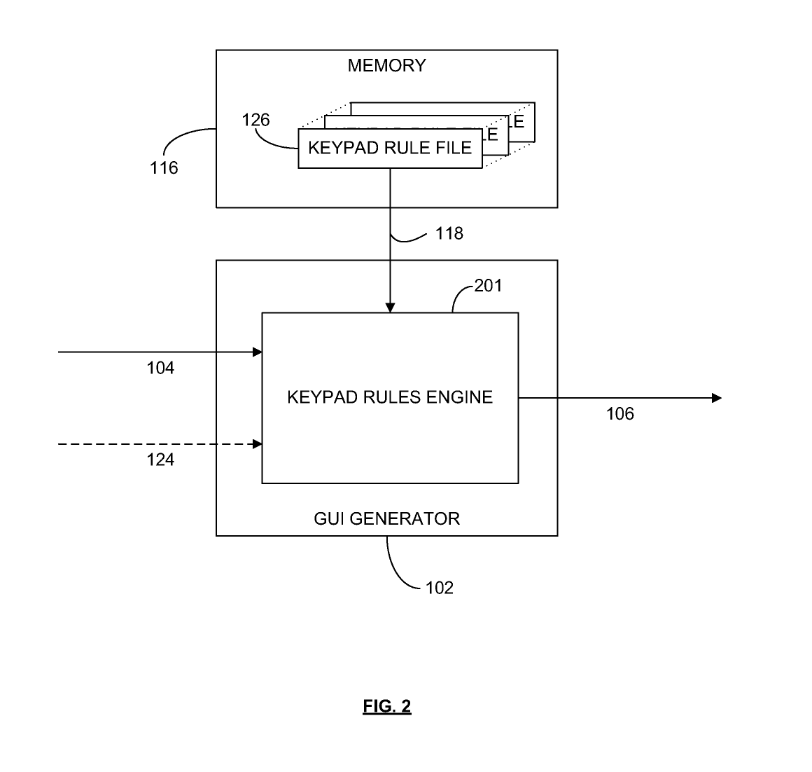

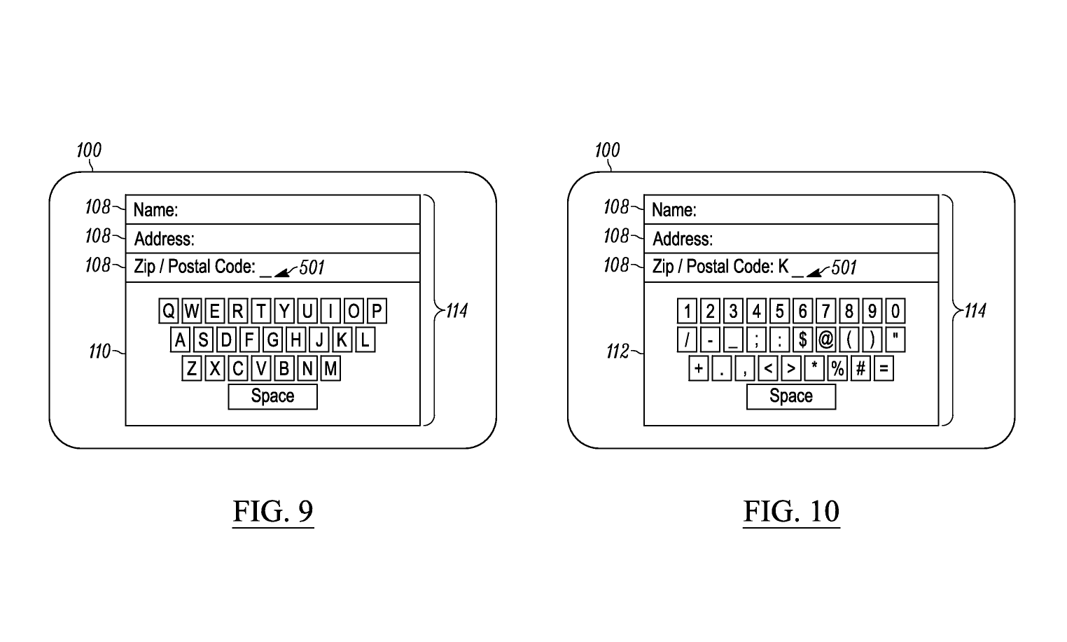

Referring now to FIG. 2, in accordance with one example of the present disclosure, the GUI generator 102 comprises a keypad rules engine 201. The keypad rules engine 201 may comprise, for example, software executing on a processor (e.g., the GUI generator 102 in one example), a combinational logic circuit, an application specific integrated circuit, a state machine, and/or other suitable component(s) providing the described functionality. As shown, the keypad rules engine 201 is operative to obtain keypad rule information 118, keypad descriptor metadata 104, and apparatus location information 124. The keypad rule information 118, keypad descriptor metadata 104, and apparatus location information 124 may be obtained in the same manner that the GUI generator 102 obtained this information/data, as described previously. The keypad rules engine 201 is further operative to apply the rule information 118 to the keypad descriptor metadata 104 and the apparatus location information 124 to determine which of the plurality of available keypad GUIs to alternatively provide for display on the touch-screen display 114 during a data field population session. This functionality is best illustrated with reference to FIGS. 9-10.

For example, FIG. 9 depicts a situation in which a user is about to enter a Canadian postal code into the Zip/Postal Code data field 108 of the device 100 using a first keypad GUI 110. The active space within the data field (i.e., the space in which a character will be displayed following the selection of an icon of a keypad GUI 106) is indicated by a cursor 501. In this example, the keypad descriptor metadata 104 merely defines two alternative keypad GUIs 106 that may be provided by the GUI generator 102 for this data field 108. That is to say, in this example, the keypad descriptor metadata 104 fails to define when to switch between first and second keypad GUIs 110, 112.

However, at this stage, the rules engine 201 has already obtained the aforementioned keypad descriptor metadata 104, along with keypad rule information 118 and apparatus location information 124. The apparatus location information 124 indicates that the device/apparatus 100 is located in Canada. Further, the rule information 118 indicates that the GUI generator 102 should alternate between providing a first keypad GUI 110 comprising selectable icons representing alphabetic characters and modifier(s) and a second keypad GUI 112 comprising selectable icons representing numeric characters and modifier(s) when the apparatus location information 124 indicates that the device/apparatus 100 is located in Canada. This is because the rule information 118 has been composed to account for the known structure of Canadian postal codes. Specifically, the rule information 118 indicates that Canadian postal codes take the form: letter, number, letter, space, number, letter, number. Hence, as shown in FIG. 9, the first keypad GUI is comprised of selectable icons representing alphabetic characters because the first character in a Canadian postal code is guaranteed to be a letter, and it is assumed that a user would want to type in a Canadian postal code based on their location. FIG. 10 illustrates the apparatus of FIG. 9 after the user has entered the first character of the postal code (i.e., “k”). As shown in FIG. 10, the display 114 now displays a second keypad GUI 112 comprising selectable icons representing numeric characters (along with special characters and modifiers). Again, this is because the rule information 118 indicates that the second character in a Canadian postal code is a number. This process illustrates how the rules engine 201 is operative to apply the rule information 118 to the keypad descriptor metadata 104 and the apparatus location information 124 to determine which of the plurality of available keypad GUIs 106 to alternatively provide for display on the touch-screen display 114 during a field population session. Of course, after a user enters a number into the active space of the Zip/Postal Code field 108 of FIG. 10 (again, represented by the location of the cursor 501), the GUI generator will once again provide the first keypad GUI 110 for the same data field 108 during the same field population session.

Referring now to FIG. 8, another illustration of the functionality of the GUI generator 102 is depicted. FIG. 8 depicts a situation wherein the location-determining component 122 has detected a change in the location of the apparatus 100. For the purposes of this example, suppose that the location-determining component 122 detected that the apparatus 100 crossed the border from the Canadian province of Ontario (which is generally English speaking) to the province of Quebec (which is generally French speaking). In accordance with the previously discussed functionality of the rules engine 201, the rules engine 201 applies the rule information 118 to the keypad descriptor metadata 104 and the newly detected apparatus location information 124. In response, the GUI generator 201 provides a user-prompt GUI 801. The user-prompt GUI 801 allows a user to change the language associated with each keypad GUI 106 from a first language (e.g., English) to a second language (e.g., French). In another example, the keypad descriptor metadata 104 and/or the rule information 118 could instruct the GUI generator 102 to automatically change the language associated with the keypad GUIs 106 without prompting the user (i.e., automatically).

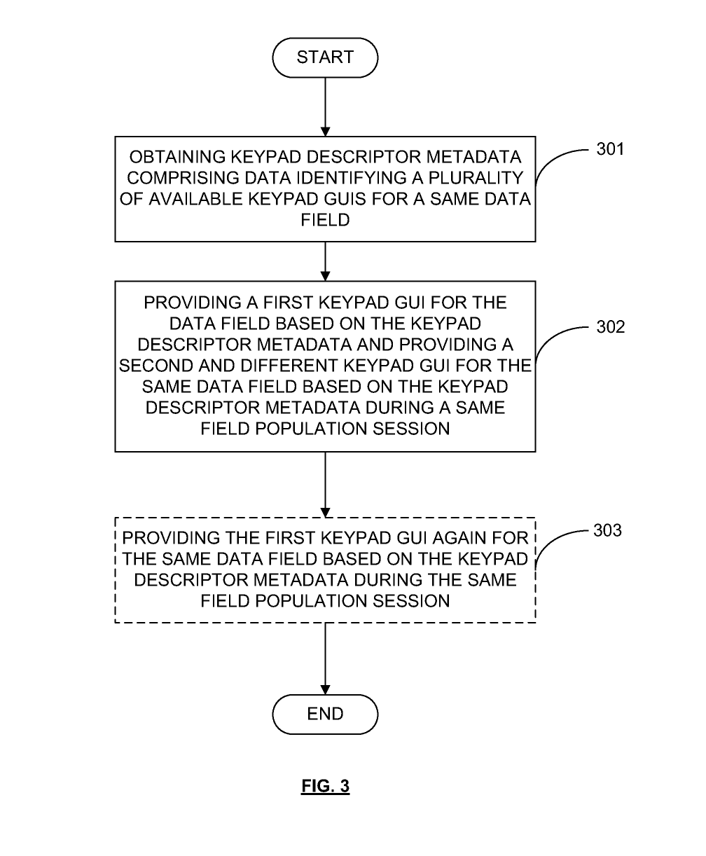

Referring now to FIG. 3, a method for providing a GUI in accordance with the present disclosure is illustrated. At step 301, keypad descriptor metadata is obtained, wherein the keypad descriptor metadata comprises data identifying a plurality of available keypad GUIs for a same data field. In one example, the keypad descriptor metadata may be the keypad descriptor metadata 104 described and discussed with respect to FIGS. 1-2 above. At step 302, a first keypad GUI is provided for the data field based on the keypad descriptor metadata. In one example, the first keypad GUI may be the first keypad GUI 110 described above and depicted in FIGS. 1, 5, and 7-9. Similarly, in one example, the data field of step 302 may be the data field 108 described above and depicted in FIGS. 1 and 5-10. Also at step 302, a second and different keypad GUI is provided for the same data field based on the keypad descriptor metadata during a same field population session. In one example, the second and different keypad GUI may be the second and different keypad GUI 112 described above and depicted in FIGS. 1, 6, and 10. Finally, optional step 303 includes providing the first keypad GUI again for the same data field based on the keypad descriptor metadata during the same field population session. In one example, the operations described in steps 301-303 may be carried out by the GUI generator 102 depicted in FIGS. 1-2 and described in detail above.

Referring now to FIG. 4, another method for providing a GUI in accordance with the present disclosure is illustrated. At step 401, keypad descriptor metadata is obtained, wherein the keypad descriptor metadata comprises data identifying a plurality of available keypad GUIs for a same data field. In one example, the keypad descriptor metadata may be the keypad descriptor metadata 104 described and discussed with respect to FIGS. 1-2 above. At step 402, a first keypad GUI is provided for the data field based on the keypad descriptor metadata and based on device location information. In one example, the first keypad GUI may be the first keypad GUI 110 described above and depicted in FIGS. 1, 5, and 7-9. Specifically, the first keypad GUI of step 402 may be the first keypad GUI 110 depicted in FIG. 9, wherein the first keypad GUI 110 comprises selectable icons representative of alphabetic characters based on the apparatus location information 124 indicating that the apparatus is located in Canada. Similarly, in one example, the data field of step 402 may be the data field 108 described above and depicted in FIGS. 1 and 5-10. Also, in one example, the device location information may be the device location information 124 described above and depicted in FIGS. 1-2. Also at step 402, a second and different keypad GUI is provided for the same data field based on the keypad descriptor metadata and based on the device location information during a same field population session. In one example, the second and different keypad GUI may be the second and different keypad GUI 112 described above and depicted in FIGS. 1, 6, and 10. Specifically, the second and different keypad GUI of step 402 may be the second and different keypad GUI 112 depicted in FIG. 10, wherein the second and different keypad GUI 112 comprises selectable icons representative of numeric characters based on the apparatus location information 124 indicating that the apparatus 100 is located in Canada. In one example, the operations described in steps 401-402 may be carried out by the GUI generator 102 comprising the rules engine 201 depicted in FIGS. 1-2 and described in detail above.

At optional step 403, a language associated with each keypad GUI is changed from a first language to a second language based on the device location information. In one example, the functionality of step 403 may be accomplished by the GUI generator 102 comprising the rules engine 201 as described with respect to FIG. 8. Specifically, the keypad descriptor metadata 104 and/or the rule information 118 could instruct the GUI generator 102 to automatically change the language associated with the keypad GUIs 106 without prompting the user (i.e., automatically).

At optional step 404, a user-prompt GUI is provided in response to detecting a change in device location information, wherein the user-prompt GUI allows for the changing of a language associated with each keypad GUI from a first language to a second language. In one example, this step may be carried out in the manner discussed with respect to FIG. 8 above. Finally, at optional step 405, the first keypad GUI is provided again for the same data field based on the keypad descriptor metadata and based on the device location information during the same field population session. In one example, this step may be carried out in the manner discussed with respect to FIGS. 9-10 above.

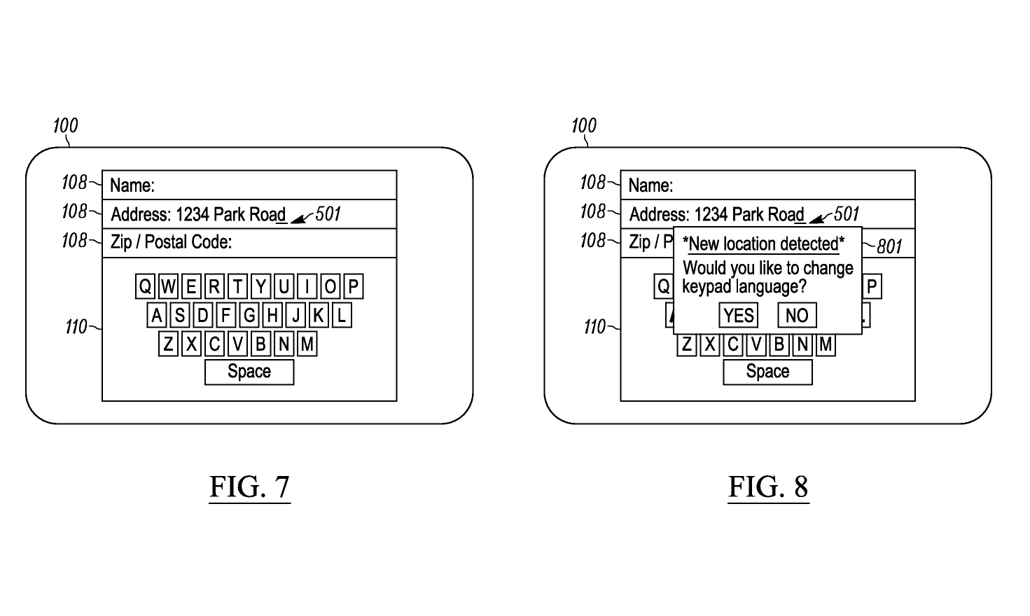

Referring now to FIGS. 5-6, the apparatus 100 is depicted in a vertical display mode. Conversely, in FIGS. 7-11, the apparatus 100 is depicted in horizontal (i.e., landscape) mode. As discussed above, a user of the apparatus may affect a change in the display mode from a vertical display mode to a horizontal display mode (or vice versa) by rotating the apparatus 90 degrees relative to the user.

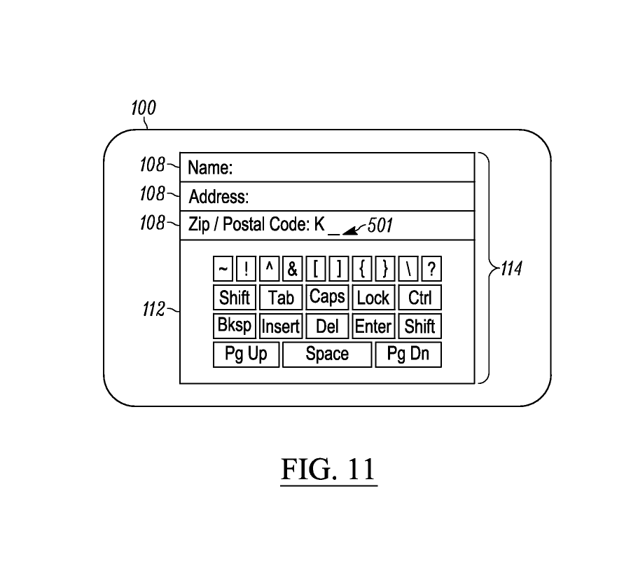

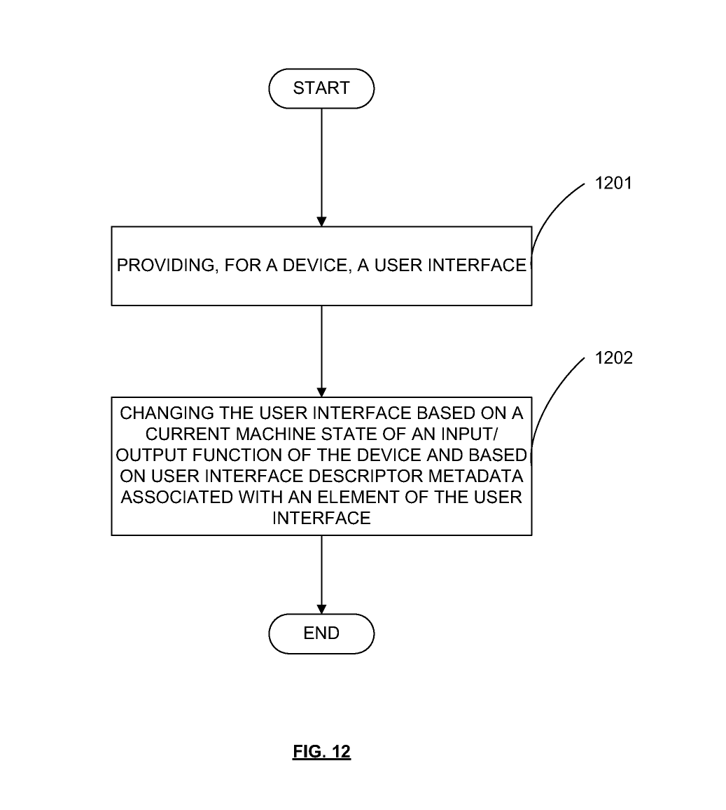

FIG. 11 is an illustration of the apparatus of FIG. 10 depicting an alternate embodiment of a second keypad GUI 112. This embodiment includes selectable icons representing additional modifiers (e.g., “Shift,” “Tab,” “Caps,” etc.) and additional special characters (e.g., “˜,” “!,” “̂,” etc.). Of course, either the first or second keypad GUIs 110, 112 may contain any suitable combination of selectable icons representing alphabetic characters, numeric characters, special characters, and/or modifiers.

FIG. 12 is a flowchart illustrating one example of a method for providing a user interface. At step 1201, a user interface provided for a device. A wide variety of different types of user interfaces are contemplated for use with the present method. For example, the user interface may include an attentive user interface (e.g., a vibration activation/deactivation system), a graphical user interface (GUI), a web-based user interface (e.g., a web page being viewed on a web browser), or any other suitable user interface known in the art. Furthermore, as noted above, the device may comprise, for example, any of the following electronic devices: a cellular telephone, a personal digital assistant (PDA), a tablet (e.g., an Apple® iPad®), a desktop or notebook PC, a camera, a self-service kiosk, an automated teller machine, a video game console (e.g., Nintendo DS®), a satellite navigation device, a networked computing device (e.g., a server), or any other suitable electronic device.

At step 1202, the user interface is changed based on the current machine state of an input/output function of the device and based on user interface descriptor metadata associated with a user interface element. The current machine state of an input/output function of the device is, for example, data indicating the current setting of an input/output function of a device. For example, an input function may be a user input function such as a keypad, mouse, microphone, GUI, or other suitable input function. Accordingly, the current machine state of an input function of a device describes, for example, whether keys on the keypad are depressed (thereby indicting user input), whether the mouse is moving, whether the microphone is capturing sound, whether a user is interacting/manipulating a GUI, etc. An output function may be, for example, vibration activation/deactivation, audio output, GUI, or any other suitable output function. Accordingly, the current machine state of an output function of a device describes, for example, whether the device is vibrating, whether the speakers are precluded from outputting sound (i.e., whether the device is muted), whether a particular GUI is being displayed, etc.

User interface descriptor metadata is data associated with an element of a user interface that controls how a particular user interface changes based on the current machine state of an input/output function of a device. For example, a media playing GUI (e.g., Windows Media Player) is comprised of several elements such as a play button, a fast forward button, a rewind button, etc. User interface descriptor metadata may be associated with one or more of these individual elements.

For example, user interface descriptor metadata may be associated with the play button element of a media playing GUI. This association may be accomplished by tagging the play button with user interface descriptor metadata as known in the art. In this example, the current machine state being monitored may be the machine state of the audio output function (i.e., whether the device is in “mute-mode” or not). In this example, the media playing GUI may change in the sense that a pop-up window may be displayed asking the user if they would like to un-mute the device in response to the user selecting the play button element of the media playing GUI (e.g., by clicking on the play button with the mouse cursor). In this example, the user interface descriptor metadata associated with the play-button element of the media playing GUI controls how the user interface is changed (e.g., whether to provide a pop-up window, whether to change the visual layout of the original GUI, etc.).

In another example, the user interface that is provided may be a web browser displaying a web page. In this example, user interface descriptor metadata may be associated with a video element of the webpage (e.g., the presence of a video clip on a particular web page as recognized, for example, by the video clip's file name—e.g., “.mpeg”—that is embedded in the web page's code). As with the previous example, the current machine state being monitored may be the machine state of the audio output function (i.e., whether the device is in “mute-mode” or not). In this example, the web-based user interface may change to display a pop-up window asking the user if they would like to un-mute the device in response to detecting the presence of a video element of the web-based user interface. In this example, the user interface descriptor metadata associated with the video element of the web-based user interface controls how the user interface is changed (e.g., whether to provide a pop-up window, whether to change the visual layout of the original web-based user interface, etc.). Other examples will be appreciated by those skilled in the art.

Among other advantages, the disclosed apparatus and methods intelligently provide specific control of user interfaces, such as but not limited to keypad GUIs based on metadata that has been appended to a particular data field, thereby eliminating the time-consuming and inefficient need to manually switch between different keypad GUIs or having to interface to control other input/output systems (e.g., a mouse, vibrator, audio system etc.). The disclosed apparatus and methods also provide a more relevant keypad GUI at any given moment by taking into account considerations such as the geographic location of the device, the anticipated structure of data being entered into particular data fields, and the language that is spoken in particular geographic regions. Other advantages will be recognized by those of ordinary skill in the art.

Also, integrated circuit design systems (e.g., work stations) are known that create integrated circuits based on executable instructions stored on a computer readable memory such as but not limited to CDROM, RAM, other forms of ROM, hard drives, distributed memory, etc. The instructions may be represented by any suitable language such as but not limited to hardware descriptor language or other suitable language. As such, the GUI generator described herein may also be produced as integrated circuits by such systems. For example an integrated circuit may be created using instructions stored on a computer readable medium that when executed cause the integrated circuit design system to create an integrated circuit that is operative to obtain keypad descriptor metadata comprising data identifying a plurality of available keypad GUIs for a same data field and provide a first keypad GUI for the data field based on the keypad descriptor metadata and provide a second and different keypad GUI for the same data field based on the keypad descriptor metadata during a same field population session. Integrated circuits having the logic that performs other of the operations described herein may also be suitably produced.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. A method for providing a user interface (UI), the method comprising:
obtaining keypad descriptor metadata comprising data identifying a plurality of available keypad graphical user interfaces (GUIs) for a same data field; and
providing a first keypad GUI for the data field based on the keypad descriptor metadata and providing a second and different keypad GUI for the same data field based on the keypad descriptor metadata during a same field population session.

2. The method of claim 1, wherein providing comprises applying rule information to the keypad descriptor metadata to determine which of the plurality of available keypad GUIs to alternatively display during the field population session.

3. The method of claim 1, wherein the keypad descriptor metadata defines which of the plurality of available keypad GUIs to alternatively display during the field population session.

4. The method of claim 1, wherein providing the second and different keypad GUI is also based on input into the first keypad GUI.

5. The method of claim 1, wherein obtaining comprises extracting the keypad descriptor metadata from an HTML form.

6. The method of claim 1, further comprising:
providing the first keypad GUI again for the same data field based on the keypad descriptor metadata during the same field population session.

7. A method for providing a user interface (UI), the method comprising:
obtaining keypad descriptor metadata comprising data identifying a plurality of available keypad graphical user interfaces (GUIs) for a same data field; and
providing a first keypad GUI for the data field based on the keypad descriptor metadata and based on device location information and providing a second and different keypad GUI for the same data field based on the keypad descriptor metadata and based on the device location information during a same field population session.

8. The method of claim 7, wherein providing comprises applying rule information to the keypad descriptor metadata to determine which of the plurality of available keypad GUIs to alternatively display during the field population session.

9. The method of claim 7, wherein providing the second and different keypad GUI is based on input into the first keypad GUI.

10. The method of claim 7, further comprising changing a language associated with each keypad GUI from a first language to a second language based on the device location information.

11. The method of claim 7, further comprising:
providing a user-prompt GUI in response to detecting a change in device location information, wherein the user-prompt GUI allows for the changing of a language associated with each keypad GUI from a first language to a second language.

12. The method of claim 7, further comprising:
providing the first keypad GUI again for the same data field based on the keypad descriptor metadata and based on the device location information during the same field population session.

13. An apparatus comprising:
a user interface (UI) generator, the UI generator operative to:
obtain keypad descriptor metadata comprising data identifying a plurality of available keypad graphical user interfaces (GUIs) for a same data field; and
provide a first keypad GUI for the data field based on the keypad descriptor metadata and provide a second and different keypad GUI for the same data field based on the keypad descriptor metadata during a same field population session; and
a touch-screen display operatively connected to the GUI generator, the touch-screen display operative to display at least one data field and the provided keypad GUI.

14. The apparatus of claim 13, further comprising:
memory operatively connected to the GUI generator and operative to store rule information, wherein the GUI generator is further operative to apply the rule information to the keypad descriptor metadata to determine which of the plurality of available keypad GUIs to alternatively provide for display on the touch-screen display during the field population session.

15. The apparatus of claim 13, wherein each keypad GUI is operative to accept input via the touch-screen display and wherein the GUI generator is further operative to provide the second and different keypad GUI based on input into the first keypad GUI.

16. The apparatus of claim 13, further comprising memory operatively connected to the GUI generator, wherein the memory is operative to store an HTML form comprising the keypad descriptor metadata.

17. The apparatus of claim 16, wherein the HTML form is associated with at least one of:
an address data field;
a zip/postal code data field;
an email address data field;
a telephone number data field; and
a fax number data field.

18. The apparatus of claim 13, further comprising a location-determining component operatively connected to the GUI generator and operative to detect apparatus location information.

19. The apparatus of claim 18, wherein the GUI generator comprises a rules engine operative to:
obtain keypad rule information, keypad descriptor metadata, and apparatus location information; and
apply the rule information to the keypad descriptor metadata and the apparatus location information to determine which of the plurality of available keypad GUIs to alternatively provide for display on the touch-screen display during the field population session.

20. The apparatus of claim 18, wherein the GUI generator is further operative to provide a user-prompt GUI in response to the location-determining component detecting a change in the location of the apparatus, wherein the user-prompt GUI allows for the changing of a language associated with each keypad GUI from a first language to a second language.

21. A method for providing a user interface comprising;
providing, for a device, a user interface; and
changing the user interface based on a current machine state of an input/output function of the device and based on user interface descriptor metadata associated with an element of the user interface.

22. The method of claim 21, wherein changing comprises applying rule information to the user interface descriptor metadata to change the user interface from one of a plurality of available user interfaces to a different user interface.

23. The method of claim 21, wherein the user interface is a graphical user interface.
